(19) United States
(12) Patent Application Publication
(10) Pub. No.: US 2013/0167519 A1
(43) Pub. Date: Jul. 4, 2013

(54) Door Controller for Vehicles and Method for Actuating a Cylinder of a Vehicle Door

(71) Applicants: Ingo Hellbusch, Springe (DE); Uwe Stabenow, Laatzen (DE)

(72) Inventors: Ingo Hellbusch, Springe (DE); Uwe Stabenow, Laatzen (DE)

(73) Assignee: WABCO GmbH, Hannover (DE)

(21) Appl. No.: 13/821,829

(22) PCT Filed: Jun. 10, 2011
(86) PCT No.: PCT/EP2011/002853

§ 371 Date: Mar. 8, 2013

(30) Foreign Application Priority Data
Sep. 14, 2010 (DE) 10 2010 045 337.4

(51) Int. Cl. E05F 15/02

(52) U.S. Cl. CPC E05F 15/02
USPC 60/327; 60/412

(57) ABSTRACT

The invention relates to a door control system for vehicles, with a compressor (1), an air dryer (3), a door control valve (4) and at least one cylinder (2) which can be actuated by compressed air, and also relates to a method for actuating a cylinder (2) of a vehicle door, in which a piston (13) of the cylinder (2) can occupy a first functional position (O) and a second functional position (X). The air dryer (3), in drying mode, is exposed to throughflow of the air flowing into the cylinder (2) and in regeneration mode is exposed to throughflow by the air discharging from the cylinder (2). The cylinder (2) is pressurised only with compressed air from a compressed air accumulator (7).

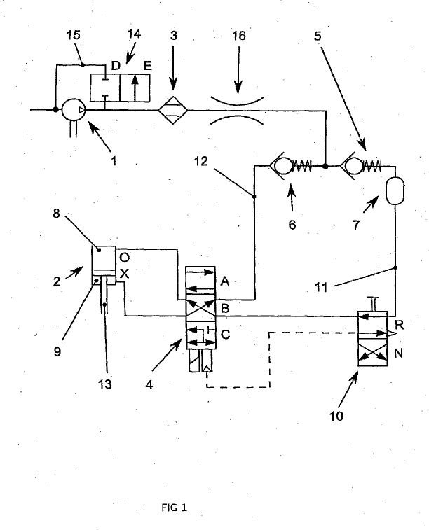

The invention relates to a pneumatic door control system for vehicles, with a compressor, an air dryer, a door control valve and at least one cylinder which can be actuated by compressed air. The invention also relates to a method for actuating a cylinder of a vehicle door, in which a cylinder of the piston can occupy at least a first functional position and a second functional position.

A pneumatic vehicle door control system, with a double-acting cylinder, which is connected to the vehicle door, the two cylinder chambers of which are connected to the compressor via valves, is known from DE 10 2008 011 315 A1. When the cylinder is being ventilated, the compressed air is relieved into the atmosphere.

As a rule, moisture is extracted from the compressed air, which is produced by a compressor, in an air dryer since dry compressed air has higher quality, which has inter alia a positive effect upon the service life of the pneumatic system. Such an air dryer must be periodically manually drained and/or regenerated by means of additionally supplied heat. In the event of failure of the regeneration devices or interruption or incorrect performing of maintenance, there is the risk of icing of the system.

The invention is based on the object of creating a possibility of operating a door control system inter alia in a manner which is as energy saving and free of maintenance as possible.

This object is achieved according to the invention with a device according to the features of claim 1. The additional embodiments of the invention are set forth in the dependent claims.

According to the invention, provision is therefore made for a device in which the cylinder, by means of the door control valve, can be connected via a first flow path to an air dryer and to a compressor for filling, and can be connected via a second flow path to the air dryer and to atmosphere for emptying. In this case, the air dryer can be operated in drying mode when the cylinder is being filled and operated in regeneration mode when the cylinder is being emptied. In drying mode, the air dryer is exposed to throughflow of the air flowing into the cylinder, and in regeneration mode, is exposed to throughflow of air flowing out of the cylinder. As a result of this, it becomes possible that during each door operation, that is to say during each cylinder cycle, the ventilated air flows through the air dryer, absorbs moisture there, and discharges this to atmosphere. The air dryer is therefore regenerated during each cylinder cycle, as a result of which maintenance intervals can be reduced to a minimum or completely dispensed with since the air dryer no longer has to be drained manually. Also, the risk of icing of the pneumatic system therefore no longer exists.

It is favourable that the first flow path and the second flow path are disconnected from each other by means of a cylinder-side check valve and an accumulator-side check valve. As a result of this, it is ensured that the routing of air in the door control system, especially the flow of air through the first flow path and the second flow path, is correctly carried out.

It is advantageous that a compressed air accumulator is provided in the first flow path between the air dryer and the door control valve downstream of the accumulator-side check valve. The compressed air accumulator serves for receiving compressed air from the compressor and for delivering compressed air to the cylinder. The compressed air, which is received by compressed air accumulator, has been dried beforehand in the air dryer which is operated in drying mode. The arrangement of the compressed air accumulator in the first flow path makes it possible on the one hand that the compressed air accumulator, as a reservoir, is able to receive sufficient compressed air for a plurality of cylinder cycles and therefore that the compressor can be dimensioned with lower power consumption and also smaller overall size and has the capability of being operated almost continuously. A compressor which is optimised as a result of the low power consumption of the engine and a low mass contributes to a low energy demand of the vehicle. On the other hand, this arrangement makes it possible for the ventilation to be carried out quickly and therefore for a speedy door operation to be achieved.

It is advantageous that the compressor can be bypassed by means of a vent valve. As a result of this, it is possible that no flow has to pass through the compressor when the cylinder is being emptied, as a result of which a fast emptying is ensured.

As a cylinder for operating a vehicle door, cylinders with only one chamber can be provided. As a rule, a double-acting cylinder with two chambers is used. In this case, it is favourable that the one of the two cylinder chambers can be connected to atmosphere via the door control valve, and the other of the two cylinder chambers can be connected to the compressed air accumulator via the door control valve, or that both cylinder chambers can be connected to the compressed air accumulator and/or to atmosphere via the door control valve.

The object is also achieved according to the invention by a method according to the features of claim 7. The additional embodiments of the invention are to be set forth in the dependent claims.

According to the method, provision is therefore made for a method in which a door control valve is actuated for switching between the first functional position and the second functional position of the piston of the cylinder, wherein the compressed air flows from the first cylinder chamber or from the second cylinder chamber for venting to atmosphere, and the other of the first cylinder chamber or of the second cylinder chamber is filled with compressed air from the compressed air accumulator. The air which discharges from the one cylinder chamber makes its way via a second flow path, via the cylinder-side check valve, to the air dryer which is exposed to throughflow of the discharging air and is regenerated in the process. The discharging air is then finally discharged to atmosphere, via a vent valve, via a bypass of the compressor. At the same time, compressed air from a compressed air accumulator, which is arranged in the first flow path between an accumulator-side check valve and the door control valve, flows into the other cylinder chamber via said first flow path.

The cylinder is only pressurised with compressed air from the compressed air accumulator, as a result of which it is possible that the compressor can be dimensioned with lower power consumption and also smaller overall size. The compressed air accumulator, which serves as a reservoir, is used in this case as an energy accumulator and can supply the system with high volumetric flows when required. For another thing, it becomes possible that at the same time with the filling of the one cylinder chamber the compressed air from the other cylinder chamber, when being emptied, flows through the air dryer and regenerates this.

It is advantageous that before the actuation of the door control valve the vent valve is brought into a ventilating switched position in which a bypass of the compressor is opened. As a result of this, is becomes possible that during the actuation of the door control valve a lower pressure prevails in the second flow path than in the first flow path. Therefore, in combination with the check valves it is ensured that when the cylinder is being emptied the discharging air does not escape again into the compressed air accumulator but escapes through the air dryer into the atmosphere. The establishing of the said pressure differential furthermore enables the use of low-maintenance, inexpensive, spring-loaded check valves. In place of check valves, switchable valves can also be provided.

It is also favourable that after the cylinder piston has been moved the vent valve is brought into a compressed-air switched position in which the bypass of the compressor is closed. The compressed air accumulator can then be replenished when required by the compressor being put into operation.

It is an advantageous development of the invention that with an actuation of a relief valve for emergency unlocking the door control valve is brought into a third switched position in which the first cylinder chamber and the second cylinder chamber are connected to atmosphere. As a result of this, it becomes possible for the vehicle door to be freely movable, only against the frictional resistance of its mounting.

Represented in the drawing is an exemplary embodiment of the invention which is described in more detail in the following text. The drawing shows a pneumatic door control system in a schematic representation with a compressor 1 for producing compressed air, a cylinder 2 for operating a vehicle door, an air dryer 3 and a door control valve 4. The cylinder 2 has a first chamber 8 and a second chamber 9 which are separated from each other by means of a piston 13 which is movably arranged in the cylinder 2. The cylinder piston 13 can systematically occupy a first functional position O and a second functional position X, wherein the cylinder piston 13 occupies the second functional position X as soon as the first cylinder chamber 8 is pressurised. If the second cylinder chamber 9 is pressurised, then the cylinder piston 13 is in the first functional position O.

A switch between the first functional position O and the second functional position X is achieved by a change of a first switched position A and a second switched position B of the door control valve 4. In the depicted representation, the door control valve 4 is in the second switched position B. Consequently, the first cylinder chamber 8 is connected via a first flow path 11 to the compressed air accumulator 7 and filled with compressed air. The compressed air in the first cylinder chamber 8 exerts a force upon the cylinder piston 13 so that this is moved into the second functional position X and held there.

If the door control valve 4 is actuated, that is to say brought into the first switched position A, for example, then the first cylinder chamber 8, which is filled with compressed air, is emptied, and the second cylinder chamber 9 is filled with compressed air. The air which escapes from the first cylinder chamber 8 makes its way via the second flow path 12, via a cylinder-side check valve 6, to the air dryer 3. The air dryer 3 is exposed to throughflow by the escaping air and regenerated in the process. The discharging air can then finally be discharged to atmosphere via the vent valve 14 in a ventilating switched position E via a bypass 15 of the compressor 1. At the same time, compressed air from a compressed air accumulator 7 flows via the first flow path 11 into the second cylinder chamber 9. In order to prevent an inflow of the discharging air into the compressed air accumulator 7, the vent valve 14 is actuated just ahead of the door control valve 4, as a result of which the pressure in the second flow path 12 is lower than in the first flow path 11.

After the switching of the cylinder piston between the first functional position O and the second functional position X, the vent valve 14, as shown in the FIGURE, is brought into the compressed-air switched position D for closing the bypass 15. Compressed air, which is produced by the compressor 1, can now be dried in the air dryer 3 and can flow back into the compressed air accumulator 7 in order to fill this.

The first flow path 11 is disconnected from the second flow path 12 by means of the cylinder-side check valve 6 and by means of an accumulator-side check valve 5. A restrictor 16 is arranged between the check valves 5, 6 and the air dryer 3.

For emergency unlocking of the vehicle door, provision is made for a relief valve 10 which during control actuation is in a control switched position R and for emergency unlocking is set in an emergency switched position N, wherein in the emergency switched position N of the relief valve 10 the compressed air from the compressed air accumulator 7 sets the door control valve 4 in a third switched position C. This results in the first cylinder chamber 8 and the second cylinder chamber 9 being connected via the relief valve 10 to atmosphere and therefore being in an unpressurised state. If the first cylinder chamber 8 and the second cylinder chamber 9 are in an unpressurised state, the vehicle door can easily be moved by hand.

1. Door control system for vehicles, with a compressor (1), an air dryer (3), a door control valve (4) and at least one cylinder (2) which can be actuated by compressed air, characterized in that the cylinder (2), by means of the door control valve (4), can be connected via a first flow path (11) to an air dryer (3) and to a compressor (1) for filling, and can be connected via a second flow path (12) to the air dryer (3) and to atmosphere for emptying.

2. Door control system according to claim 1, characterized in that the first flow path (11) and the second flow path (12) are disconnected from each other via an accumulator-side check valve (5) and a cylinder-side check valve (6).

3. Door control system according to claim 1 or 2, characterized in that a compressed air accumulator (7) for receiving compressed air from the compressor (1) and for delivering compressed air to the cylinder (2) is provided in the first flow path (11) between the air dryer (3) and the door control valve (4) downstream of the accumulator-side check valve (5).

4. Door control system according to at least one of the preceding claims, characterized in that the compressor (1) can be bypassed by means of a vent valve (14).

5. Door control system according to at least one of the preceding claims, characterized in that the cylinder (2) is a double-acting cylinder with a first chamber (8) and a second chamber (9).

6. Door control system according to claim 5, characterized in that the first cylinder chamber (8) and the second cylinder chamber (9) can be connected by means of the door control valve (4) to the compressed air accumulator (7) and/or to atmosphere alternately.

7. Method for actuating a cylinder (2) of a vehicle door, in which a piston (13) of the cylinder (2) can occupy a first functional position (O) and a second functional position (X), characterized in that for switching of the first functional position (O) and the second functional position (X) a door control valve (4) is actuated, wherein the compressed air from either the first cylinder chamber (8) or the second cylinder chamber (9) flows to atmosphere for venting and the other of the first cylinder chamber (8) or the second cylinder chamber (9) is filled with compressed air from the compressed air accumulator (7).

8. Method according to claim 7, characterized in that before the actuation of the door control valve (4) the vent valve (14) is brought into a ventilating switched position (E) and therefore a bypass (15) of the compressor (1) is opened.

9. Method according to at least one of the preceding claims 7 and 8, characterized in that after the switching between the first functional position (O) and the second functional position (X) of the cylinder piston (13) has been carried out, the vent valve (14) is brought into a compressed-air switched position (D) and therefore the bypass (15) of the compressor (1) is closed.

10. Method according to at least one of the preceding claims 7 to 9, characterized in that when a relief valve (10) is actuated for emergency unlocking, the first cylinder chamber (8) and the second cylinder chamber (9) are connected to atmosphere.
